(19) United States
(12) Patent Application Publication
(10) Pub. No.: US 2026/0010320 A1
(43) Pub. Date: Jan. 8, 2026

(54) PRINTING APPARATUS, CONTROL METHOD THEREOF, AND STORAGE MEDIUM

(71) Applicant: CANON KABUSHIKI KAISHA, Tokyo (JP)

(72) Inventor: MASATO FUKUDA, Tokyo (JP)

(21) Appl. No.: 19/256,807

(22) Filed: Jul. 1, 2025

(30) Foreign Application Priority Data
Jul. 5, 2024 (JP) 2024-109090

(51) Int. Cl. G06F 3/12

(52) U.S. Cl. CPC G06F 3/1207; G06F 3/1204; G06F 3/1253; G06F 3/1259

(57) ABSTRACT

The present disclosure is directed to a printing apparatus comprising: one or more memory devices that store a set of instructions; and one or more processors that execute the set of instructions to: obtain a number of sheets that are printable in the printing apparatus and managed externally to the printing apparatus; accept a job; execute the job; and present the obtained number of printable sheets, and during execution of the job and before update of the externally managed number of printable sheets, update the obtained number of printable sheets based on the number of sheets for which printing has been completed and present the updated number of printable sheets.

### BACKGROUND

### Field of the Technology

The present disclosure relates to a printing apparatus, a control method thereof, and a storage medium.

### Description of the Related Art

In printing apparatuses, it is possible to limit a number of printable sheets according to a contract or the like. In this case, when the number of printable sheets is reached, no further printing can be performed, and the contract needs to be renewed. Japanese Patent Laid-Open No. 2023-59672 proposes a technique for registering, in advance in a blockchain, print permission details, including the number of printable sheets, in relation to image data and controlling permission and non-permission of printing according to the print permission details.

However, since transmitting a transaction to a blockchain requires a consensus, a reflection wait time occurs from when a transaction is transmitted until when it is reflected in the blockchain. Therefore, in general, transactions are not transmitted at intervals shorter than the above reflection wait time, such as a printing time for one page. As a result, during continuous printing, there will be a discrepancy between the number of printable sheets saved on the blockchain and the actual number of printable sheets, and thus, the user cannot know an accurate number of printable sheets value from blockchain information. Thus, when the number of printable sheets is managed externally to the printing apparatus as in a blockchain network or the like, it is difficult to update the number of printable sheets in real time during printing, resulting in a discrepancy between the obtained number of printable sheets and the actual number of printable sheets.

### SUMMARY

The present disclosure enables realization of a mechanism that suitably presents the number of printable sheets.

One aspect of the present disclosure provides a printing apparatus comprising: one or more memory devices that store a set of instructions; and one or more processors that execute the set of instructions to: obtain a number of sheets that are printable in the printing apparatus and managed externally to the printing apparatus; accept a job; execute the job; and present the obtained number of printable sheets, and during execution of the job and before update of the externally managed number of printable sheets, update the obtained number of printable sheets based on the number of sheets for which printing has been completed and present the updated number of printable sheets.

Another aspect of the present disclosure provides a method for controlling a printing apparatus, the method comprising: obtaining a number of sheets that are printable in the printing apparatus and managed external to the printing apparatus; accepting a job; executing the job; presenting the obtained number of printable sheets, and during execution of the job and before update of the externally managed number of printable sheets, updating the obtained number of printable sheets based on the number of sheets for which printing has been completed and presenting the updated number of printable sheets.

Still another aspect of the present disclosure provides a non-transitory computer-readable storage medium storing a computer program for causing a computer to execute each step in a method for controlling a printing apparatus, the method comprising: obtaining a number of sheets that are printable in the printing apparatus and managed external to the printing apparatus; accepting a job; executing the job; presenting the obtained number of printable sheets, and during execution of the job and before update of the externally managed number of printable sheets, updating the obtained number of printable sheets based on the number of sheets for which printing has been completed and presenting the updated number of printable sheets.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram of a configuration of a system according to one embodiment.

FIG. 2 is a hardware block diagram of an image forming apparatus according to one embodiment.

FIG. 3 is a hardware block diagram of a management server according to one embodiment.

FIGS. 4A to 4G are diagrams illustrating a screen flow for print processing according to one embodiment.

FIGS. 5A to 5F are diagrams illustrating a screen flow for copy processing according to one embodiment.

FIGS. 6A-6B are a flowchart for explaining an example of print job processing of the image forming apparatus according to one embodiment.

FIG. 7 is a flowchart for explaining an example of QR code generation processing of the image forming apparatus according to one embodiment.

FIG. 8 is a flowchart for explaining an example of processing for generating a URL for purchasing the number of printable sheets by the management server according to one embodiment.

FIG. 9 is an example of print execution result transaction data according to one embodiment.

FIGS. 10A and 10B are diagrams illustrating a screen flow for an NFT status confirmation screen according to one embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### Configuration of System

An embodiment of the present disclosure will be described below. An image forming apparatus according to the present embodiment is an example of an image processing apparatus. A public key and a private key, which will be described in the present embodiment, are keys in public-key cryptography, and encryption and decryption of electronic data, as well as digital signature and verification, can be performed using any key generation algorithm, encryption algorithm, and decryption algorithm.

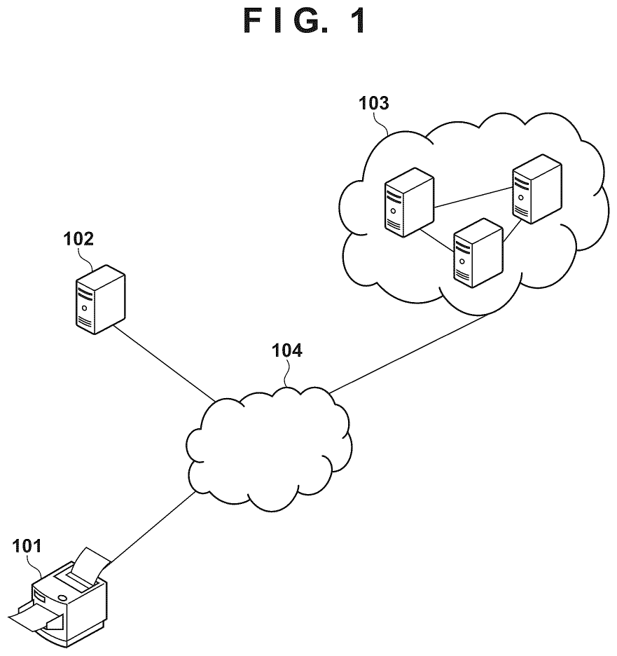

An example of a configuration of a system according to the present embodiment will be described with reference to FIG. 1. As illustrated in FIG. 1, the system according to the present embodiment is configured to include, for example, an image forming apparatus 101, a management server 102, a blockchain network 103, and the Internet 104. The image forming apparatus 101, the management server 102, and the blockchain network 103 can communicate with each other via the Internet 104. A configuration may be taken so as to connect not one but a plurality of each of the image forming apparatus 101, the management server 102, and the blockchain network 103.

The image forming apparatus 101 is an example of a printing apparatus and is a multifunction peripheral, which has a plurality of functions such as copying, scanning, printing, and faxing. The image forming apparatus 101 may be an apparatus that has a single function, such as a printer or a scanner, or may be any apparatus (printing apparatus) that includes a printing function. The management server 102 is constituted by one or more cloud servers and, upon receiving a request to obtain a URL for purchasing the number of printable sheets from the image forming apparatus 101, generates a new token in the blockchain network 103 via the Internet 104. Further, the management server 102 obtains a token whose owner is a wallet address of the management server 102. Furthermore, the management server 102 transmits the URL for purchasing the number of printable sheets to the image forming apparatus 101 via the Internet 104. The number of printable sheets may be information associated with the image forming apparatus 101 or information associated with each user or group (organization). Further, in the present embodiment, a form in which the number of printable sheets managed on the blockchain network 103 is used will be described. However, the present technical is not limited to the blockchain network and can be applied to any form that uses the number of printable sheets managed externally to the image forming apparatus 101 as in a cloud network or the like.

The blockchain network 103 is a network constituted by a plurality of nodes. Each node holds a blockchain in which pieces of data called blocks formed by a plurality of transactions and headers are linked in a time series. Information processing apparatuses connected to the Internet 104, including the image forming apparatus 101 and the management server 102, transmit transaction data to a blockchain URL “http://BC1.io”. This allows a transaction generation request to be made to the blockchain network 103. Upon receiving a transaction generation request, the blockchain network 103 broadcasts transaction data to each node on the blockchain. Then, the nodes of the blockchain network 103 use a consensus algorithm such as Proof of Work (PoW) and Proof of Stake (PoS) to verify that the transmitted transaction data is valid. If the transmitted transaction data is valid transaction data, the transaction is stored based on the transaction data transmitted to the blockchain held by each node. In the present embodiment, a format of transaction data is exemplified by data created in a JavaScript Object Notation (JSON) format but is not limited thereto.

FIG. 9 illustrates an example of transaction data. The transaction data is configured to include transactionID, prev, from, timestamp, digest, verificationKey, encryptKey, method, and input parameters. “transactionID” indicates a transaction ID, which is uniquely determined for each transaction. “prev” indicates a previous transaction digest for which a previous transaction, which indicates an immediately preceding transaction, has been encrypted using a private key of the transferor. “from” indicates a transmission source, which is a wallet address generated from a wallet held by the transferor of ownership. “timestamp” indicates a timestamp indicating the time when the transaction was generated. “digest” indicates a digital certificate digest for proving that the transmission source generated the transaction. “verificationKey” indicates an owner verification public key for verifying the transmission source of the transaction. “encryptKey” indicates a data encryption public key for encrypting image data. “method” indicates a method name that specifies an API of a contract block. “input” indicates parameters to be passed to the method.

Further, the blockchain network 103 saves contract blocks from information processing terminals via the Internet 104. A contract block contains a smart contract, which is a mechanism for executing a program such as referencing and decreasing the number of printable sheets. The smart contract executes the program by specifying a blockchain URL and a contract address, which is an address for identifying the contract block in which the smart contract to be executed is stored, and transmitting an API and parameters, from the information processing terminal. The Application Interface (API) includes an API corresponding to the processing to be executed, such as “getCounter” or “Print”. The parameters include, for example, parameters necessary for respective processes such as “wallet address” and “number of sheets to be printed”. Further, the smart contract can specify the wallet address that generated the contract block as the owner, and each API can be set to be executable either only when the transmission source is the owner or by any transmission source. In the present embodiment, a “MINT” API for creating a new Non-Fungible Token (NFT), which is a token that is not fungible, can be executed only by the owner. The owner of a contract address “0xABCDEF123456” is assumed to be a wallet address “0x33334444”. Further, although in the present embodiment a method for transmitting transaction data in a JSON format exemplifies a method for executing a smart contract, it is not intended to limit the present technical.

### Hardware Configuration of Image Forming Apparatus

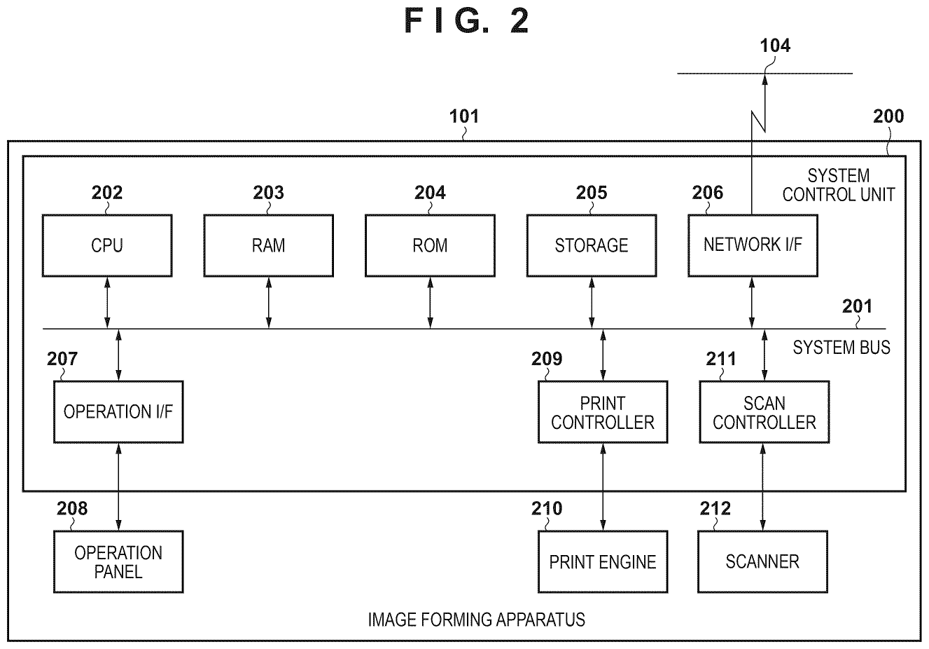

An example of a hardware configuration of the image forming apparatus 101 according to the present embodiment will be described with reference to FIG. 2. The image forming apparatus 101 includes a system control unit 200, an operation panel 208, a print engine 210, and a scanner 212. The system control unit 200 includes a CPU 202, a RAM 203, a ROM 204, a storage 205, a network I/F 206, an operation I/F 207, a print controller 209, and a scan controller 211. The respective units are connected to a system bus 201 and are capable of exchanging data with each other.

The Central Processing Unit (CPU) 202 controls the operation of the entire image forming apparatus 101. The CPU 202 reads control programs stored in the ROM 204 or the storage 205 and performs various kinds of control such as read control and print control. The RAM 203 is a main storage memory of the CPU 202 and is used as a work area and a temporary storage region for loading various control programs stored in the ROM 204 and the storage 205. The ROM 204 stores control programs that can be executed by the CPU 202. In the present embodiment, control firmware for controlling the image forming apparatus 101 and a QR code encoder for generating a QR code (two-dimensional code) are stored.

The storage 205 stores print data, image data, various programs, and various kinds of setting information. According to the present embodiment, the storage 205 stores a Hierarchical Deterministic (HD) wallet, which is a mechanism for hierarchically creating private keys, and an HD wallet program for managing an HD wallet. “0x11112222”, which is one of the wallet addresses stored in an HD wallet in the storage 205, may be stored in association with various setting information in the image forming apparatus, such as administrator information and user information, in the HD wallet. Further, a plurality of HD wallets may be stored in the image forming apparatus 101. The storage 205 further stores the blockchain URL “https://BC1.io” and the contract address “0xABCDEF123456”, which are information for obtaining the number of printable sheets from the blockchain network 103. Furthermore, the storage 205 stores a request URL for purchasing an NFT “https://aaa.com/buyNFT”, which is a request URL of the management server 102. Here, the request URL for purchasing an NFT is an example of an access destination for purchasing the number of printed sheets.

In the image forming apparatus 101 according to the present embodiment, one CPU 202 executes respective processes indicated in flowcharts to be described later by using one memory (RAM 203), but the respective processes may be realized in another form. For example, a plurality of CPUs, RAMs, ROMs, and storages can work together to execute the respective processes indicated in the flowcharts to be described later. Further, a hardware circuit such as an Application Specific Integrated Circuit (ASIC) or a Field-Programmable Gate Array (FPGA) may be used to execute some of the processes.

The network I/F 206 is an interface for causing the image forming apparatus 101 to communicate with an external apparatus via the Internet 104. The CPU 202 receives electronic data managed by any information processing apparatus on the Internet 104 via the network I/F 206 and uses the print engine 210 to print it. Further, the CPU 202 transmits transaction data to the blockchain network 103 via the network I/F 206.

The operation panel 208 is an example of a display unit and displays a screen controlled by the operation I/F 207. Upon operation of the operation panel 208 by the user, the image forming apparatus 101 obtains an event corresponding to the user operation via the operation I/F 207.

The print controller 209 is connected to the print engine 210. Image data to be printed is transferred to the print engine 210 via the print controller 209. The print engine 210 receives control commands and image data to be printed and forms an image that is based on the image data on a sheet. A printing method of the print engine 210 may be an electrophotographic method or an inkjet method. In the case of the electrophotographic method, an image is formed by forming an electrostatic latent image on a photosensitive body then developing it with toner, transferring that toner image to a sheet, and fixing the transferred toner image. Meanwhile, in the case of the inkjet method, an image is formed on a sheet by discharging ink.

The scan controller 211 is connected to the scanner 212. The scanner 212 reads an image on a sheet and generates image data. The image data generated by the scanner 212 is stored in the storage 205. The image forming apparatus 101 may form an image on a sheet by using the image data generated by the scanner 212. The scanner 212 includes a document feeder (not illustrated) and can read sheets placed on the document feeder while conveying them one at a time.

### Hardware Configuration of Management Server

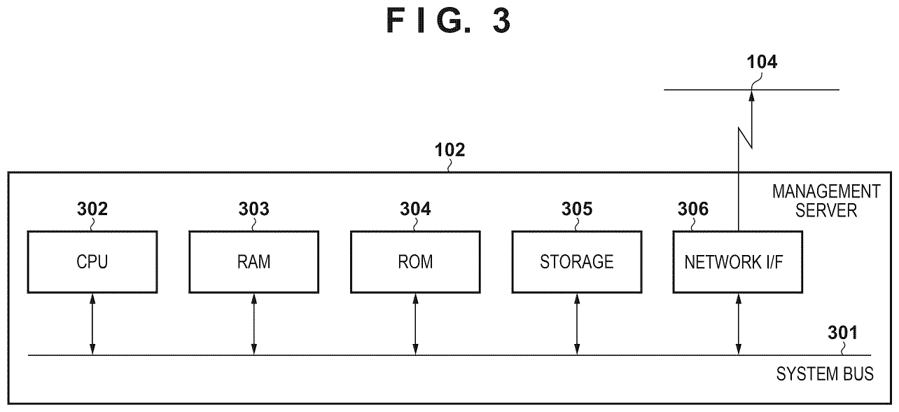

An example of a hardware configuration of the management server 102 according to the present embodiment will be described with reference to FIG. 3. As illustrated in FIG. 3, the management server 102 includes a CPU 302, a RAM 303, a ROM 304, a storage 305, and a network I/F 306 connected to system bus 301.

The CPU 302 is a central processing unit (CPU) that controls the operation of the entire management server 102. The RAM 303 is a volatile memory. The ROM 304 is a non-volatile memory and stores a startup program for the CPU 302. The storage 305 is a storage apparatus (e.g., a hard disk drive (HDD)) with larger capacity than the RAM 303, and the storage 305 stores an HD wallet and an HD wallet program that manages the HD wallet. “0x33334444”, which is one of the wallet addresses stored in the HD wallet of the storage 305, is the owner of the contract address “0xABCDEF123456”. This allows the management server 102 to generate a new token by using the contract address “0xABCDEF123456”.

The storage 305 may be a solid state drive (SSD) or the like and may be replaced by another storage apparatus that includes functions similar to those of a hard disk drive. The CPU 302 communicates with the image forming apparatus 101 via the network I/F 306. Furthermore, the CPU 302 transmits transaction data to the blockchain network 103 via the network I/F 306 and obtains transactions on the blockchain network 103.

### Screen Transition During Print Processing

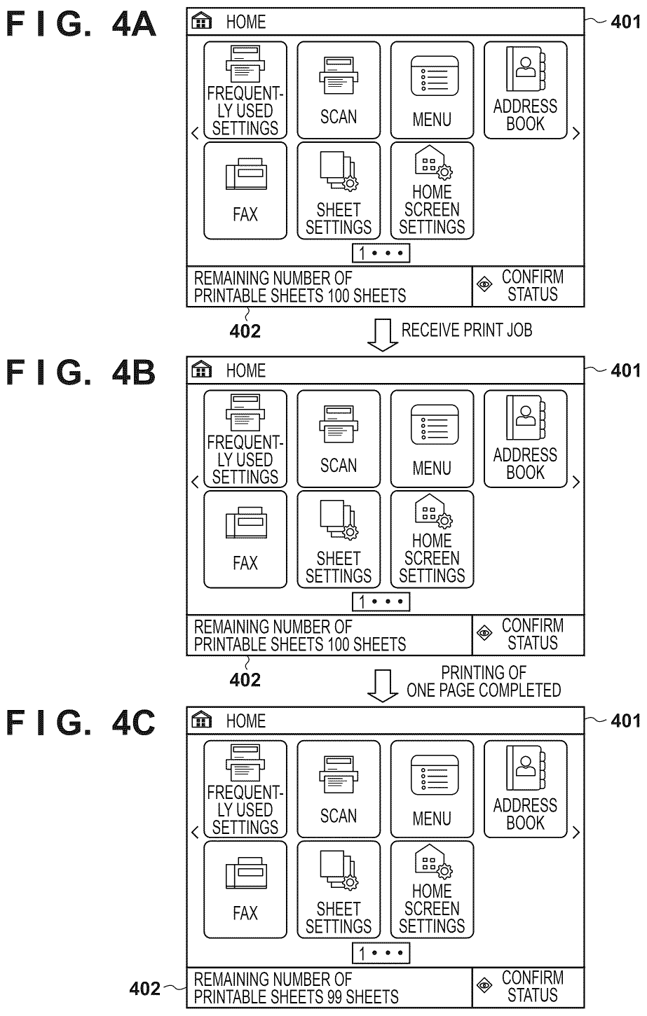

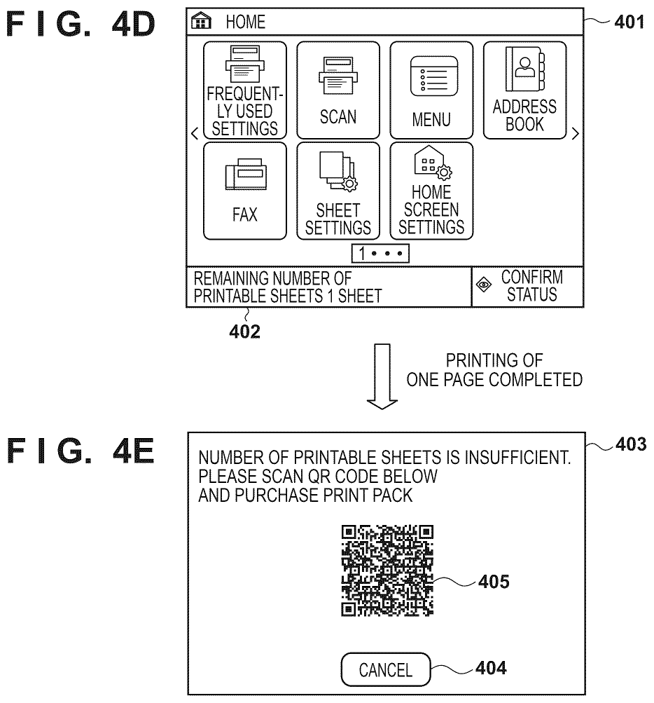

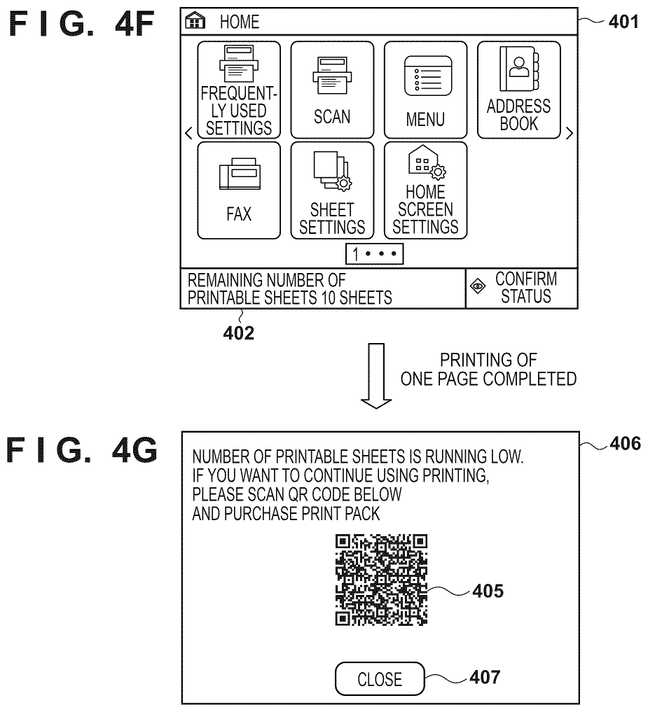

Screen transition at the time of print processing according to the present embodiment will be described with reference to FIGS. 4A to 4G. Each screen is displayed on the operation panel 208 of the image forming apparatus 101. Although a form in which the number of printable sheets is displayed on a screen displayed on the operation panel 208 will be described here, it is not intended to limit the present technical. For example, display may be made on a screen (setting screen or printing-in-progress screen) of a printer driver in an external apparatus, such as a PC on which a print job or the like is inputted.

As illustrated in FIG. 4A, a home screen 401 is a basic menu screen of the image forming apparatus 101, and objects for executing various functions provided by the image forming apparatus 101 are displayed in a selectable manner. Further, according to the present embodiment, the remaining number of printable sheets is displayed on a status line 402. Here, the remaining number of printable sheets is displayed to be 100 sheets. The remaining number of printable sheets displayed here is the number of printable sheets managed by the blockchain network 103.

FIG. 4B illustrates the home screen 401 upon reception of a print job from an external apparatus in the state of FIG. 4A. In the status line 402 of FIG. 4B, 100 sheets, which is the same remaining number of printable sheets as in FIG. 4A, is displayed. That is, the state of FIG. 4B is a state in which not even one page has been printed in printing of the received print job. The print job may be received via the operation panel 208 or from an external apparatus (not illustrated) via the network I/F 206. Therefore, the operation panel 208 and the network I/F 206 are examples of a reception unit.

FIG. 4C illustrates the home screen 401 in a state in which printing of one page has been completed in the received print job. In the status line 402 of FIG. 4C, 99 sheets, which is the remaining number of printable sheets, is displayed. As described above, according to the present embodiment, each time printing of one page (one sheet) is completed in the local image forming apparatus 101, the remaining number of printable sheets that is displayed in the status line 402 is updated from the number of printable sheets “100 sheets”, which is managed on the server side. Here, the remaining number of printable sheets is not information that is updated on the blockchain network 103, which manages the number of printable sheets, upon completion of printing of one page but is information updated locally in the image forming apparatus 101. The number of printable sheets may be managed in units of pages or in units of sheets. In the case of management in units of pages, the number of printable pages may be updated for each predetermined number of pages (e.g., one page). Meanwhile, in the case of management in units of sheets, the number of printable sheets may be updated for each predetermined number of sheets (e.g., one sheet). In the present embodiment, control in the case of management in units of sheets will be described, but the case of management in units of pages can also be handled. Further, although a form in which the number of printable sheets is updated each time printing of one sheet is completed will be described, it is not intended to limit the present technical, and a form in which it is updated for each desired number of sheets is applicable.

FIG. 4D illustrates the home screen 401 for when the remaining number of printable sheets is one sheet. In the status line 402, one sheet, which is the remaining number of printable sheets, is displayed. FIG. 4E illustrates a screen 403 to be displayed when printing of one page has been completed from the state of FIG. 4D but printing of the print job has not been completed. That is, the screen 403 is a screen to be displayed when the remaining number of printable sheets is insufficient and the print job cannot be completed. In the screen 403, a message indicating that the number of printable sheets is insufficient, a QR code 405, and a cancel button 404 are displayed. The QR code 405 is a two-dimensional code for purchasing a print pack to increase the number of printable sheets. The user can be redirected to a page for buying and selling an NFT for the number of printable sheets on an NFT marketplace, such as OpenSea, for example, by scanning the QR code 405 on an information terminal with a QR code reader. The number of printable sheets can be increased by purchasing a print pack on that page. Upon update of the number of printable sheets, the suspended print job resumes. Meanwhile, by operating the cancel button 404, it is possible to cancel execution of the currently pending print job and return to the home screen 401.

FIG. 4F illustrates the home screen 401 for when the remaining number of printable sheets is 10 sheets. In the status line 402, 10 sheets, which is the remaining number of printable sheets, is displayed. FIG. 4G illustrates a screen 406 to be displayed when printing of one page has been completed from the state of FIG. 4F. In the screen 406, a message indicating that the number of printable sheets is running low, the QR code 405 as in the screen 403, and a close button 407 are displayed. The user can access a page for purchasing a print pack by reading the QR code 405 on an information terminal. By operating the close button 407, it is possible to close the screen 406 and return to the home screen 401.

### Screen Transition During Copy Processing

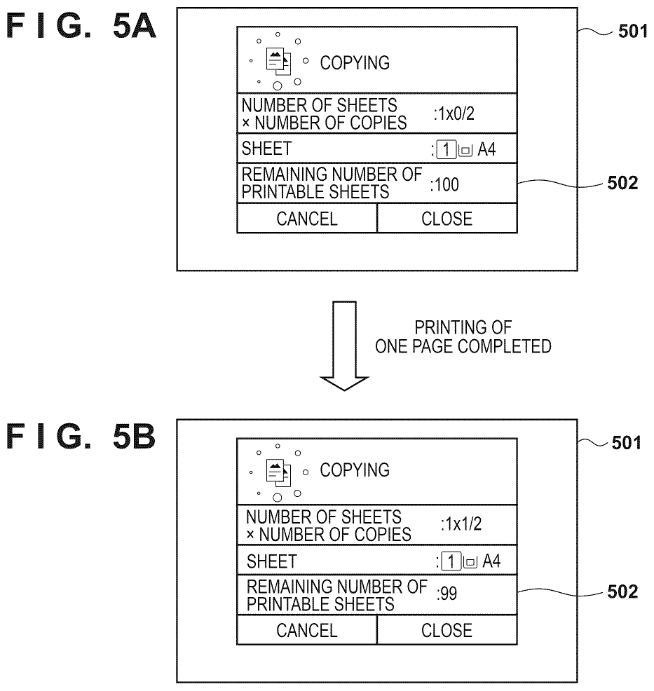

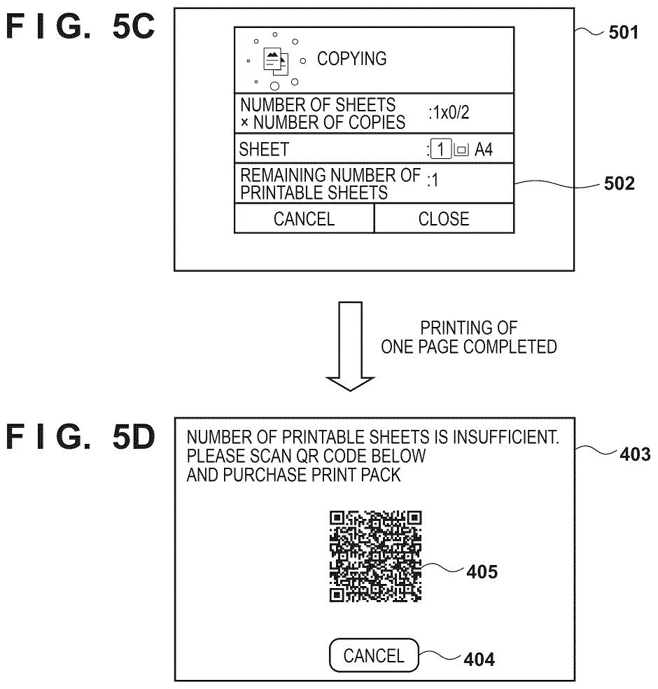

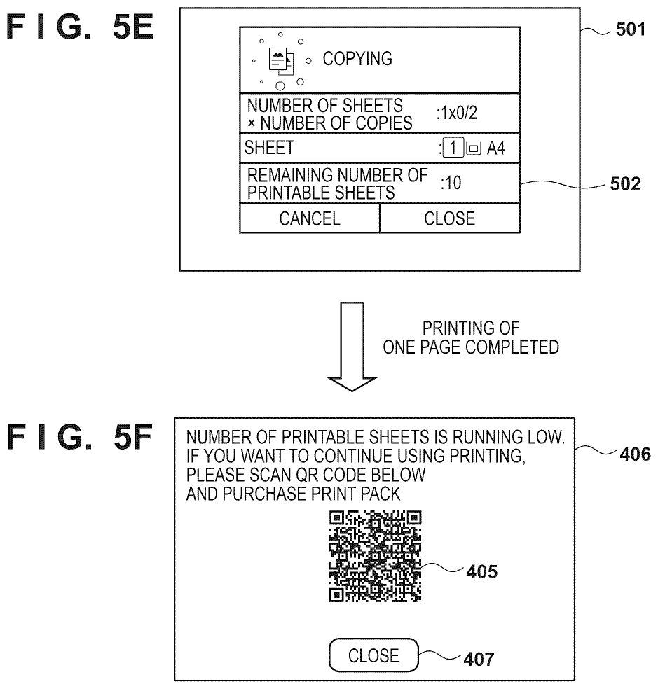

Screen transition at the time of copy processing according to the present embodiment will be described with reference to FIGS. 5A to 5F. Each screen is displayed on the operation panel 208 of the image forming apparatus 101.

FIG. 5A illustrates a copy-in-progress screen 501. In the copy-in-progress screen 501, the remaining number of printable sheets 502 is displayed in addition to copying being in progress, the number of sheets to be copied and the number of copies of the copy job, and a selected sheet size. Here, the remaining number of printable sheets is displayed to be 100 sheets. The remaining number of printable sheets displayed here is information for which the number of printable sheets managed by the blockchain network 103 has been obtained.

FIG. 5B illustrates the copy-in-progress screen 501 upon completion of copying of one page in the copy job from the state of FIG. 5A. In the number of printable sheets 502 of FIG. 5B, 99 sheets are displayed. As described above, according to the present embodiment, each time printing of one page is completed in the local image forming apparatus 101, the remaining number of printable sheets that is displayed in the number of printable sheets 502 in the copy-in-progress screen 501 is updated from the number of printable sheets “100 sheets”, which is managed on the server side. Here, the remaining number of printable sheets is not information that is updated on the blockchain network 103, which manages the number of printable sheets, upon completion of copying of one page but is information updated locally in the image forming apparatus 101.

FIG. 5C illustrates the copy-in-progress screen 501 for when the remaining number of printable sheets is one sheet. In the number of printable sheets 502, one sheet, which is the remaining number of printable sheets, is displayed. FIG. 5D illustrates the screen 403 to be displayed when copying of one page has been completed from the state of FIG. 5C but printing of the copy job has not been completed. That is, the screen 403 is a screen to be displayed when the remaining number of printable sheets is insufficient and the copy job cannot be completed. Since the screen 403 is the same screen as that of FIG. 4E, detailed description will be omitted.

FIG. 5E illustrates the copy-in-progress screen 501 for when the remaining number of printable sheets is 10 sheets. In the number of printable sheets 502, 10 sheets, which is the remaining number of printable sheets, is displayed. FIG. 5F illustrates the screen 406 to be displayed when copying of one page has been completed from the state of FIG. 5E. Since the screen 406 is the same screen as that of FIG. 4G, detailed description will be omitted.

### Print Processing

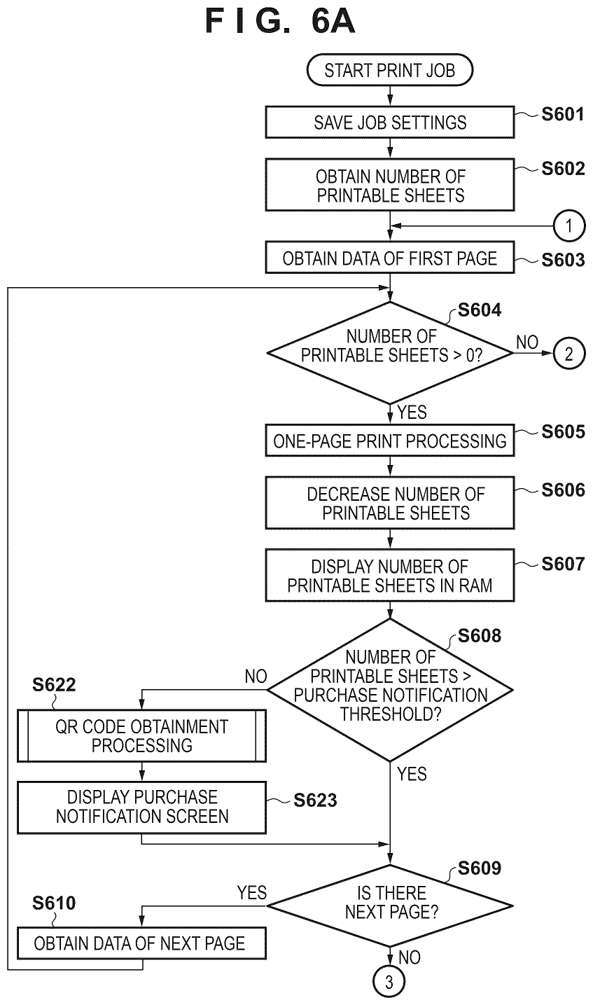

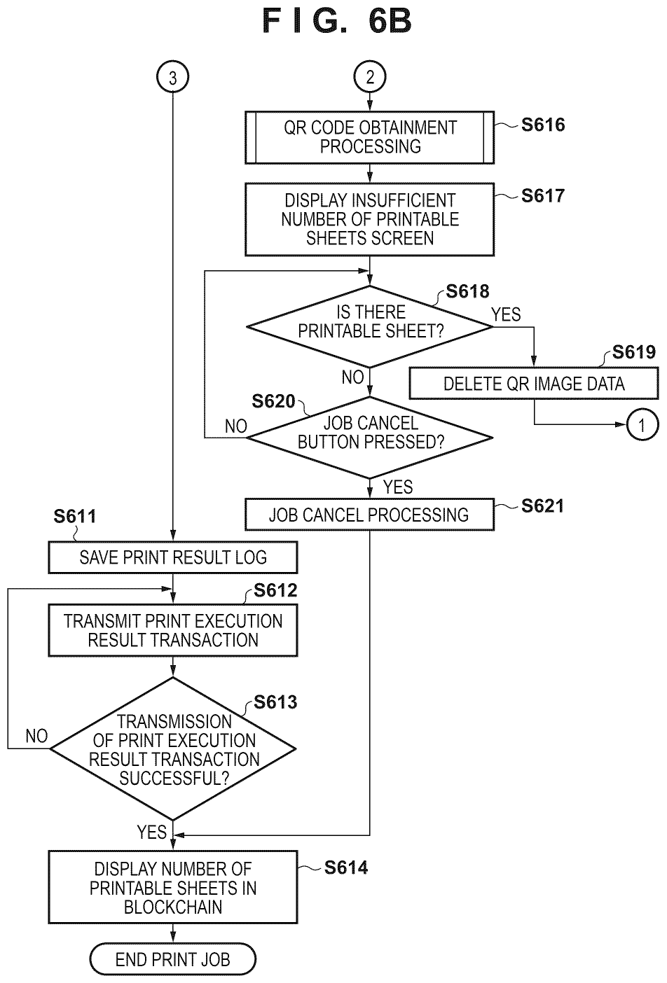

A processing procedure at the time of execution of a print job according to the present embodiment will be described with reference to FIGS. 6A-6B. The processing to be described below is realized, for example, by the CPU 202 of the image forming apparatus 101 reading out a program stored in the ROM 204 or the storage 205 to the RAM 203 and executing the program.

Upon reception of a print job by the image forming apparatus 101, the flowchart starts. The print job is started by the image forming apparatus 101 receiving the print job via the network I/F 206 or executing the print job, which has been saved in the storage 205 of the image forming apparatus 101, from the operation panel 208.

In step S601, the CPU 202 saves settings of the print job, such as the color mode and the number of copies stored in the print job, in “job settings” of the RAM 203. Then, in step S602, the CPU 202 obtains the number of printable sheets of the image forming apparatus 101 via the network I/F 206 and saves the number of printable sheets in the “number of printable sheets” of the RAM 203. More specifically, the CPU 202 transmits JSON data of a “getCounter” API to the contract address “0xABCDEF123456” of the blockchain network 103 saved in the storage 205. Here, the CPU 202 transmits the JSON data of the above API, with the wallet address “0x11112222” as a parameter, to obtain the number of printable sheets. The number of printable sheets stored in the contract address “0xABCDEF123456” may be individually managed in accordance with color settings such as the number of printable sheets for color and the number of printable sheets for black and white (monochrome). For example, when the color mode of the job generated in step S601 is “color”, the CPU 202 transmits JSON data of a “getColorCounter” API, with the above wallet address set as a parameter, to the above contract address. The CPU 202 saves, in the “number of printable sheets” of the RAM 203, the number of printable sheets for color obtained by transmitting the above API. Meanwhile, in a case where the color mode of the job generated in step S601 is “black and white (monochrome)”, the CPU 202 transmits JSON data of a “getMonoCounter” API, with the above wallet address as a parameter, to the above contract address. The CPU 202 saves, in the “number of printable sheets” of the RAM 203, the number of printable sheets for black and white obtained by transmitting the above API. The number of printable sheets may thus be individually managed in accordance with the print type. Here, a method for individual management by color mode has been described, but the present technical is not limited thereto, management may be performed according to a desired print type such as the type and size of a print sheet or print quality.

In step S603, the CPU 202 saves the data of the first page of the print job in “data of the page to be printed” of the RAM 203. Then, in step S604, the CPU 202 determines whether the “number of printable sheets” stored in the RAM 203 is greater than 0 (one or more sheets). If it is determined that the “number of printable sheets” of the RAM 203 is greater than 0, the processing proceeds to step S605, and otherwise, the processing proceeds to step S616.

In step S605, the CPU 202 causes the print controller 209 to execute print processing for the “data of the page to be printed” of the RAM 203. In step S606, the CPU 202 updates the “number of printable sheets” of the RAM 203 by subtracting one sheet. In step S607, the CPU 202 displays the updated “number of printable sheets” of the RAM 203 in the status line 402 of the operation panel 208 via the operation I/F 207. As described above, according to the present embodiment, each time a predetermined number of sheets (here, one sheet) is printed, the number of printable sheets held locally is updated before the number of printable sheets managed on the blockchain network 103 is updated. This allows the number of printable sheets to be updated as necessary and presented to the user, and even if there is a discrepancy between the number of printable sheets managed by the blockchain network 103 and the actual number of printable sheets, the user can confirm the actual number of printable sheets in real time.

Furthermore, in step S608, the CPU 202 determines whether the number of printable sheets exceeds a purchase notification threshold. Here, the purchase notification threshold is a threshold for prompting the user to purchase an additional number of sheets to be printed when the number of printable sheets is running low, and the purchase notification is issued when the number of printable sheets at the threshold or below. If it is determined that the number of printable sheets exceeds the purchase notification threshold, the processing proceeds to step S609, and otherwise, the processing proceeds to step S622.

In step S609, the CPU 202 determines whether there is data of the next page in the print job. If there is data of the next page, the processing proceeds to step S610, and otherwise, the processing proceeds to step S611. In step S610, the CPU 202 saves the data of the next page of the print job in the “data of the page to be printed” of the RAM 203 and returns the processing to step S604. Meanwhile, in step S611, the CPU 202 saves a print result in a job history of the storage 205 and proceeds to step S612.

In step S612, the CPU 202 generates print execution result transaction data based on the number of printed sheets and transmits the print execution result transaction to the blockchain network 103 via the network I/F 206. As one example, if printing of 100 pages has been executed, the CPU 202 of the image forming apparatus 101 transmits a print execution result transaction, which is an API for notifying the contract address “0xABCDEF123456” of print execution completion. In that print execution result transaction, as illustrated in FIG. 9, “Print” is specified in the “method” attribute, and “100” is set in the “param1” attribute of the parameter “input”, which indicates the number of printed pages.

In step S613, the CPU 202 obtains whether registration of the print execution result transaction has been successful from the blockchain network 103 and determines whether registration has been successful. If it is determined that registration has been successful, the processing proceeds to step S614, and if it is determined that registration has not been successful, the processing is returned to step S612. In step S614, the CPU 202 transmits JSON data of the “getCounter” API to the contract address “0xABCDEF123456” of the blockchain network 103 saved in the storage 205. Here, JSON data is transmitted with the wallet address “0x11112222” as a parameter. By transmitting JSON data of that API, the CPU 202 obtains the number of printable sheets of the image forming apparatus 101 and saves the obtained number of printable sheets in the “number of printable sheets” of the RAM 203. Furthermore, the CPU 202 displays the “number of printable sheets” of the RAM 203 in the status line 402 of the operation panel 208 via the operation I/F 207.

If it is determined that a predetermined number of failures has occurred in step S613, the CPU 202 may set a “print function permission flag” of the storage 205, which is a flag that prohibits generation of a job related to printing, to FALSE. In that case, the print execution result transaction is saved in a “retry region” of the storage 205 and is transmitted to the blockchain network 103 at predetermined time intervals until the print execution result transaction is successful.

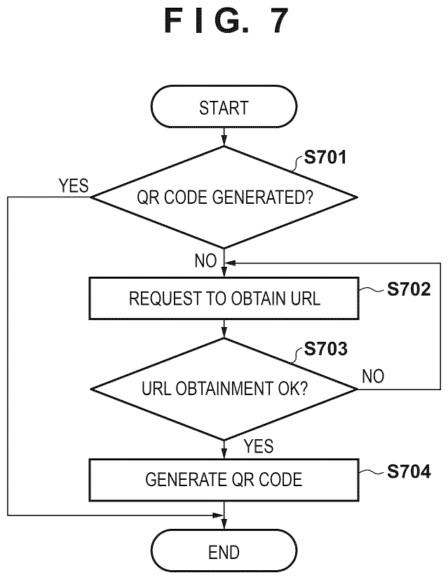

In step S604, if it is determined that the number of printable sheets falls below 1, in step S616 the CPU 202 executes processing for generating a QR code for purchasing the number of printable sheets (FIG. 7). Then, in step S617, the CPU 202 displays the screen 403, which displays the QR code 405, which has been visualized from “QR image data for purchasing the number of printable sheets” read out from the RAM 203, on the operation panel 208 via the operation I/F 207. The user scans the QR code 405 on an information terminal with a QR code reader to access an NFT marketplace or the like and uses the wallet address “0x11112222” registered in the image forming apparatus 101 to purchase the number of printable sheets at the access destination. This makes it possible to additionally purchase the number of printable sheets of the image forming apparatus 101.

In step S618, the CPU 202 transmits JSON data of the “getCounter” API, with the wallet address “0x11112222” a parameter, to the contract address “0xABCDEF123456” via the network I/F 206. With this, the CPU 202 obtains the number of printable sheets held by the image forming apparatus 101 from the blockchain network 103 and determines whether the obtained number of printable sheets is 1 or more. If the obtained number of printable sheets is 1 or more, the processing proceeds to step S619, and otherwise, the processing proceeds to step S620. In step S619, the CPU 202 deletes the “QR image data for purchasing the number of printable sheets” of the RAM 203 and returns the processing to step S603.

Meanwhile, in step S620, the CPU 202 determines whether the cancel button (operation object) 404 has been operated on the screen 403. In step S620, if it is determined that the cancel button 404 has been operated, in step S621 the CPU 202 cancels the print job being executed (strictly speaking, being suspended) and save a job result in the storage 205. Meanwhile, if the cancel button 404 has not been operated, in step S617 the CPU 202 returns the processing to step S618 and transmits the JSON data of the “getCounter” API as described above. Furthermore, the CPU 202 obtains the number of printable sheets held by the image forming apparatus 101 from the blockchain network 103 and determines whether the obtained number of printable sheets is 1 or more.

In step S608, if it is determined that the number of printable sheets is at a purchase threshold or below, in step S622 the CPU 202 executes the processing for generating a QR code for purchasing the number of printable sheets (FIG. 7). Then, in step S623, the CPU 202 displays a purchase notification screen 406, which displays the QR code 405, which has been visualized from “QR image data” read out from the RAM 203, on the operation panel 208 via the operation I/F 207. The user can be redirected to a page for buying and selling an NFT for the number of printable sheets on an NFT marketplace, such as OpenSea, for example, by scanning the QR code for purchasing the number of printable sheets on an information terminal with a QR code reader. The user uses the wallet address “0x11112222” registered in the image forming apparatus 101 to purchase the number of printable sheets on an NFT marketplace from an Internet browser and can thereby additionally purchase the number of printable sheets of the image forming apparatus 101.

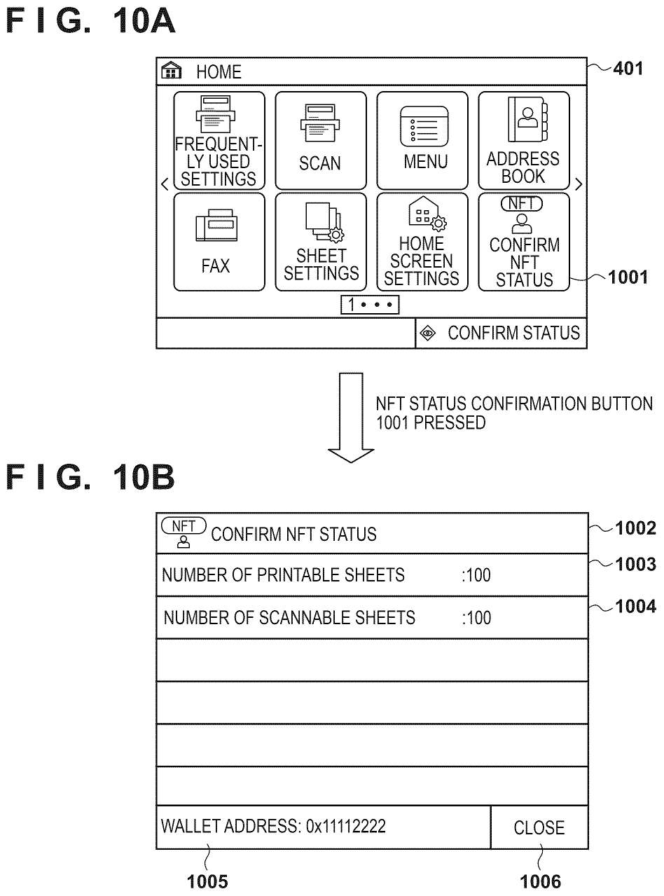

In the above embodiment, a method for receiving a print job and displaying the number of printable sheets in the status line 402 of the home screen 401 has been described, but the technical is not intended to be limited. For example, as described above, the number of printable sheets may be displayed on the number of printable sheets 502 of the copy-in-progress screen 501 when a copy job is executed. Alternatively, a wallet address 1005 may be displayed on an NFT status confirmation screen 1002 of FIG. 10B, which is displayed upon operation of an NFT status confirmation button (operation object) 1001 of the home screen 401 illustrated in FIG. 10A. In the NFT status confirmation screen 1002, an NFT held at the wallet address “0x11112222” of the image forming apparatus 101 may further be displayed as a number-of-printable-sheets display 1003 or a number-of-scannable-sheets display 1004.

### Processing for Generating QR Code for Purchasing Number of Printable Sheets

A processing procedure of QR code generation processing (steps S616 and S622) to be executed by the image forming apparatus 101 according to the present embodiment will be described with reference to FIG. 7. The processing to be described below is realized, for example, by the CPU 202 of the image forming apparatus 101 reading out a program stored in the ROM 204 or the storage 205 to the RAM 203 and executing the program.

In step S701, the CPU 202 determines whether “QR image data for purchasing the number of printable sheets” is present in the RAM 203 (has been generated). In step S701, if it is determined that “QR image data for purchasing the number of printable sheets” is not present in the RAM 203, the processing proceeds to step S702, and otherwise, the processing of this flowchart is ended. In step S702, the CPU 202 transmits HTTP GET request data to the request URL “https://aaa.com/buyNFT” for purchasing the number of printable sheets. The wallet address “0x11112222” for managing the number of printed sheets saved in the storage 205 is attached to the HTTP GET request data.

In step S703, the CPU 202 determines whether a response code of a response to obtainment of a URL for purchasing the number of printable sheets received via the network I/F 206 is “200 OK”. If it is determined that it is not “200 OK”, the processing returns to step S702, and the CPU 202 retransmits a request to obtain a URL for purchasing the number of printable sheets to the management server 102 via the network I/F 206. Here, a threshold for defining the upper limit for the number of retransmissions may be provided. In this case, if retransmissions exceed the number defined by the threshold, the result of the processing for generating a QR code for purchasing the number of printable sheets is assumed to be an error, and a screen (not illustrated) for failure to obtain a URL for purchasing the number of printable sheets may be displayed on the operation panel 208 via the operation I/F 207.

Meanwhile, step S703, if it is determined to be “200 OK”, the processing proceeds to step S704. In step S704, the CPU 202 calls a QR code encoder of the ROM 204 and converts the URL for purchasing the number of printable sheets stored in a BODY section of a URL obtainment response to QR code image data. Furthermore, the CPU 202 saves the converted QR code image data in “QR image data for purchasing the number of printable sheets” of the RAM 203 and ends the processing of this flowchart.

### Processing for Generating QR Code for Purchasing Number of Printable Sheets

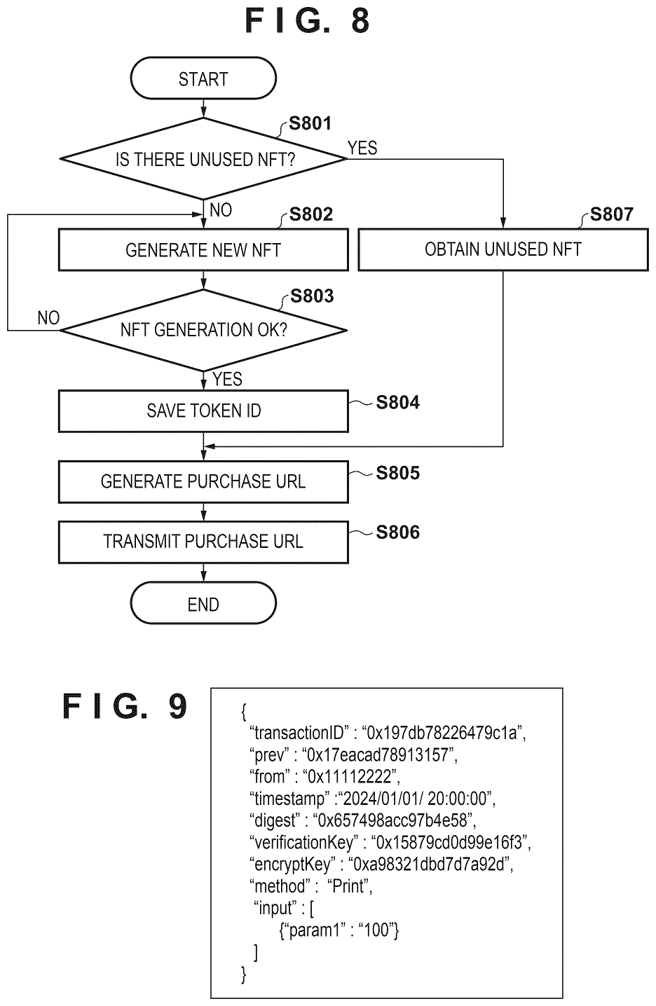

A processing procedure of processing for generating a URL for purchasing the number of printable sheets to be executed by the management server 102 according to the present embodiment will be described with reference to FIG. 8. The processing to be described below is realized, for example, by the CPU 302 of the management server 102 reading out a program stored in the ROM 304 or the storage 305 to the RAM 303 and executing the program. As described above, in step S702, the CPU 202 of the image forming apparatus 101 transmits HTTP GET request data to the request URL “https://aaa.com/buyNFT” for purchasing the number of printable sheets via the Internet 104. Upon receiving the HTTP GET request data, the CPU 302 of the management server 102 saves the BODY section of the HTTP GET request data in a “purchase request payload” of the RAM 303 and then executes the processing for generating a URL for purchasing the number of printable sheets.

In step S801, the CPU 302 of the management server 102 transmits JSON data of a “getTokens” API via the network I/F 306. In the “getTokens” API, the wallet address “0x33334444”, which is the owner of the contract, is set as a parameter for the contract address “0xABCDEF123456”. With this, the CPU 302 determines whether there is an unused NFT whose holder is still the owner. If it is determined that there is no unused NFT, the processing proceeds to step S802, and if it is determined that there is an unused NFT, the processing proceeds to step S807. In step S807, the CPU 302 saves the token ID of the unused NFT in a “purchase token ID” of the RAM 303 and advances the processing to step S805.

Meanwhile, in step S802, the CPU 302 transmits JSON data of a “Mint” API via the network I/F 306. In the “Mint” API, the wallet address “0x33334444”, which is the owner of the contract, is set as a parameter for the contract address “0xABCDEF123456” of the blockchain network 103. This makes it possible to request issuance of a new NFT.

In step S803, the CPU 302 obtains an event for a result of issuance of a new NFT requested in step S802 from the blockchain network 103 via the network I/F 306 and determines whether issuance has been successful from the issuance result event. If it is determined that issuance of a new NFT has been successful, the processing proceeds to step S804, and otherwise, the processing is returned to step S802 and the CPU 302 requests issuance of a new NFT again via the network I/F 306.

In step S804, the CPU 302 obtains a token ID from the issuance result event and saves it in the “purchase token ID” of the RAM 303. Then, in step S805, the CPU 302 generates a URL for purchasing the number of printable sheets based on the contract address “0xABCDEF123456” and the “purchase token ID” of the RAM 303 and saves it in a “purchase URL” of the RAM 303. In step S806, the CPU 302 transmits HTTP response data to which the “purchased URL” of the RAM 303 and the HTTP response code “200 OK” have been attached to the image forming apparatus 101, which is the transmission source of the HTTP GET request data, and ends the processing of this flowchart.

As described above, the printing apparatus according to the present embodiment obtains the number of sheets that are printable in the printing apparatus and managed external to the printing apparatus, accepts a job, executes the job, and presents the obtained number of printable sheets. Further, during execution of the job and before update of the externally managed number of printable sheets, the present printing apparatus updates the obtained number of printable sheets based on the number of sheets for which printing has been completed and presents it. As described above, in a printing management system that externally manages the number of printable sheets, such as on the blockchain network 103 according to the present embodiment, it is possible to update the number of printable sheets as necessary and accurately display it on a screen of a printer driver of an external apparatus or the operation panel 208 of the image forming apparatus 101. This allows the number of printable sheets to be updated and presented locally even when there is a discrepancy between the number of printable sheets managed on the blockchain network 103 and the actual number of printable sheets, which decreased due to execution of a job. Therefore, the present technical can suitably present the number of printable sheets to the user.

The present technical is not limited to the above embodiment, and various modifications are possible. In the above embodiment, a blockchain print sequence has been described, but the present technical not limited thereto, and any sequence that involves image formation such as copying may be assumed. Further, in the above embodiment, a case where the number of printable sheets is managed on a blockchain network has been given as an example, but the present technical is not limited thereto and can be applied so long as it handles the number of printable sheets managed external to the printing apparatus. Further, in the above embodiment, a URL of an NFT marketplace, which is a Web site for purchasing an NFT, is embedded in a QR code displayed on the purchase notification screen 403. However, a URL of a guide page, which is a Web page for purchasing an NFT that resides somewhere on the Internet 104, may be embedded.

In the above embodiment, the number of printable sheets is obtained from the blockchain network 103 after generation of a print job in step S602 but may be obtained at predetermined time intervals or may be obtained at startup of the image forming apparatus or when returning from the power saving mode. Further, although in the above embodiment an additional purchase screen is displayed when the number of printable sheets is insufficient, a “number-of-printable-sheets purchase screen display button” for displaying a screen for purchasing the number of printable sheets may be displayed on the home screen.

According to the present disclosure, it is possible to provide a mechanism for suitably presenting the number of printable sheets, and the user can recognize the value of the accurate number of printable sheets.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-109090, filed Jul. 5, 2024, which is hereby incorporated by reference herein in its entirety.

What is claimed is:

1. A printing apparatus comprising:
one or more memory devices that store a set of instructions; and
one or more processors that execute the set of instructions to:
obtain a number of sheets that are printable in the printing apparatus and managed externally to the printing apparatus;
accept a job;
execute the job; and
present the obtained number of printable sheets, and during execution of the job and before update of the externally managed number of printable sheets, update the obtained number of printable sheets based on the number of sheets for which printing has been completed and present the updated number of printable sheets.

2. The printing apparatus according to claim 1, wherein
the one or more processors execute instructions in the one or more memory devices to: during execution of the job, at each completion of printing of a predetermined number of sheets, update the number of printable sheets and present the updated number of printable sheets.

3. The printing apparatus according to claim 2, wherein
the one or more processors execute instructions in the one or more memory devices to: in a case where the number of printable sheets runs out, present information for increasing the number of printable sheets.

4. The printing apparatus according to claim 3, wherein
the one or more processors execute instructions in the one or more memory devices to: display, on a screen, an operation object for cancelling the job being executed, together with the information for increasing the number of printable sheets.

5. The printing apparatus according to claim 3, wherein
the one or more processors execute instructions in the one or more memory devices to: in a case where the number of printable sheets falls below a predetermined threshold, present the information for increasing the number of printable sheets.

6. The printing apparatus according to claim 3, wherein
the one or more processors execute instructions in the one or more memory devices to: present, as the information for increasing the number of printable sheets, a two-dimensional code that includes an access destination for purchasing the number of sheets to be printed.

7. The printing apparatus according to claim 1, wherein
the one or more processors execute instructions in the one or more memory devices to: display, in a display unit of the printing apparatus, information to be presented.

8. The printing apparatus according to claim 7, wherein
the one or more processors execute instructions in the one or more memory devices to: display the number of printable sheets in a status line that is in a screen displayed on the display unit of the printing apparatus and in which a status of the printing apparatus is displayed.

9. The printing apparatus according to claim 7, wherein
the one or more processors execute instructions in the one or more memory devices to: display the number of printable sheets in a screen that is transitioned to in a case where an operation object for displaying the number of printable sheets is operated in a home screen displayed on the display unit of the printing apparatus.

10. The printing apparatus according to claim 1, wherein
the one or more processors execute instructions in the one or more memory devices to: transmit, to an external apparatus that has transmitted the job, information to be presented.

11. The printing apparatus according to claim 1, wherein
the one or more processors execute instructions in the one or more memory devices to: in a case where the number of printable sheets is one or more sheets when the job is accepted, execute the job.

12. The printing apparatus according to claim 1, wherein
the number of printable sheets is managed on a blockchain network, and the one or more processors execute instructions in the one or more memory devices to:
upon completion of the job, transmit a transaction indicating a print result to the blockchain network and update the number of printable sheets managed on the blockchain network.

13. The printing apparatus according to claim 1, wherein
as the number of printable sheets, the number of printable sheets for color and the number of printable sheets for monochrome are individually managed, and
the one or more processors execute instructions in the one or more memory devices to:
obtain the number of printable sheets that corresponds to a print type of the job.

14. A method for controlling a printing apparatus, the method comprising:
obtaining a number of sheets that are printable in the printing apparatus and managed external to the printing apparatus;
accepting a job;
executing the job;
presenting the obtained number of printable sheets, and during execution of the job and before update of the externally managed number of printable sheets, updating the obtained number of printable sheets based on the number of sheets for which printing has been completed and presenting the updated number of printable sheets.

15. A non-transitory computer-readable storage medium storing a computer program for causing a computer to execute each step in a method for controlling a printing apparatus, the method comprising:
obtaining a number of sheets that are printable in the printing apparatus and managed external to the printing apparatus;
accepting a job;
executing the job;
presenting the obtained number of printable sheets, and during execution of the job and before update of the externally managed number of printable sheets, updating the obtained number of printable sheets based on the number of sheets for which printing has been completed and presenting the updated number of printable sheets.
